(19) United States
(12) Patent Application Publication
(10) Pub. No.: US 2010/0277433 A1
(43) Pub. Date: Nov. 4, 2010

(54) TOUCH PANEL DEVICE AND METHOD OF DETECTING CONTACT POSITION THEREOF

(75) Inventors: Sang-Jin Lee, Yongin-si (KR); Chul-Yong Joung, Yongin-si (KR); Bang-Won Lee, Yongin-si (KR)

Correspondence Address: CANTOR COLBURN, LLP, 20 Church Street, 22nd Floor, Hartford, CT, 06103, US

(73) Assignee: ATLAB INC., Yongin-si (KR)

(21) Appl. No.: 12/740,470

(22) PCT Filed: Apr. 30, 2008
(86) PCT No.: PCT/KR2008/002459

§ 371 Date: Apr. 29, 2010

(30) Foreign Application Priority Data
Nov. 7, 2007 (KR) 10-2007-0113090

(51) Int. Cl. G06F 3/045

(52) U.S. Cl. 345/174

(57) ABSTRACT

Provided are a touch pad device and a method of detecting a contact position thereof. The touch panel device includes: a touch panel having a surface on which at least one pair of touch patterns formed of a conductive material are formed; and a touch sensor for generating a contact signal corresponding to a contact position of a contact object using impedances of a pair of touch patterns when the pair of touch patterns are contacted by the contact object. The touch panel device includes a plurality of pairs of touch patterns formed of a conductive material. A first axis position of a contact object is determined depending on whether or not the touch patterns are contacted by the contact object, and a second axis position of the contact object is determined by detecting variations in capacitance of the touch patterns or delay times by which a reference signal applied to the touch patterns is delayed. Thus, a contact position of the contact object can be detected using the first and second axis positions. Since the touch panel uses a one-layer ITO film, manufacturing the touch panel device with improved transparency can be easy and economical.

### TECHNICAL FIELD

The present invention relates to a touch panel device, and more particularly, to a touch panel device using a conductive oxide thin layer and a method of detecting a contact position thereof.

### BACKGROUND ART

Indium tin oxide (ITO) layers are widely used as transparent conductive oxide layers for transparent electrodes of display devices, especially liquid crystal displays (LCDs). Since the ITO layers have high transparency and low sheet resistance and are easily patterned, they can be applied in various fields, for example, not only LCDs but also organic light emitting diode (OLED) devices, solar batteries, plasma display panels (PDPs), and electronic paper (e-paper), and used as ITO ink or electromagnetic shielding material for cathode-ray tube (CRT) monitors.

In general, a touch panel is installed on a surface of a display device, such as a CRT, LCD, PDP, or LED. Thus, when a user sees an image display device and applies pressure to an ITO film of the touch panel, the touch panel outputs a signal. When a finger or another contact object comes near to or contacts a screen of the touch panel, the touch panel detects a position of the finger or the other contact object. The touch panel is installed on a screen of an image display device, such as a computer or a Personal Digital Assistant (PDA), and allows anyone to easily input data on the screen using a finger or a pen without a keyboard or a mouse.

Touch panels may be classified into resistive touch panels, capacitive touch panels, ultrasonic touch panels, optical sensor touch panels (e.g., UV sensor touch panels), and electromagnetic inductive touch panels. A resistive touch panel includes two resistive sheets which are disposed to be separated by a spacer and to be in contact with each other by pressure.

FIG. 1 is a plan view of a conventional capacitive touch panel, and FIG. 2 is a cross-sectional view of the conventional capacitive touch panel taken along line H-H′ of FIG. 1.

Referring to FIGS. 1 and 2, transparent electrodes 10 and 30 are coated on top and bottom surfaces of a glass substrate 20, respectively.

The transparent electrode 30 coated on the bottom surface of the glass substrate 20 protects electronic components of the touch panel from noise generated from a display device, and the transparent electrode 10 coated on the top surface of the glass substrate 20 transmits a touch signal.

The transparent electrodes coated on the top and bottom surfaces of the glass substrate 20 may be formed of ITO or tin antimony oxide (TAO). The transparent electrodes 10 and 30 in FIG. 2 are formed of ITO.

Thereafter, metal electrodes 11 are formed along each of four sides of the transparent electrode 10.

The metal electrodes 11 form a resistance network around the transparent electrode 10, and the resistance network is formed in a linear pattern in order to uniformly transmit a control signal to the entire surface of the transparent electrode 10.

The formation of the metal electrode 11 may include directly printing silver (Ag) or a mixture of Ag and glass on the transparent electrode 10 using a silkscreen printing method and thermally treating the printed material. Alternatively, the formation of the metal electrode 11 may include depositing an ordinary conductive material and patterning the conductive material.

A protection layer 23 is coated on the entire surface of the glass substrate 20 including the metal electrodes 11.

In the capacitive touch pad having the above-described construction, the protection layer 23 prevents occurrence of an electrical short between a conductive stylus or a contact object and the transparent electrode 10 and functions as a dielectric layer.

Thus, when the conductive stylus or the contact object is located or contacted on the protection layer 23, an electromagnetic change occurs so that the capacitive touch pad can detect a contact position.

In this case, analog measurement circuits (or current sensors) (not shown) are connected to four corners of the touch panel and detect signals, and determine X-Y position coordinates through calculation processes.

The capacitive touch panel corresponds to a curved glass or a plane glass coated with a transparent metal oxide layer. In the capacitive touch panel, a voltage is applied to each of the four corners to generate a uniform electric field. Also, when a contact object is brought into contact with the capacitive touch panel, an electromagnetic change occurs, whereby a contact position is determined.

### DISCLOSURE OF INVENTION

### Technical Problem

The present invention is directed to a touch panel device using a one-layer conductive material, for example, of indium tin oxide (ITO) film.

Also, the present invention is directed to a method of detecting a contact position of a contact object in contact with a touch panel device using a one-layer conductive material.

### Technical Solution

One aspect of the present invention provides a touch panel device including: a touch panel having a surface on which at least one pair of touch patterns formed of a conductive material are formed; and a touch sensor for generating a contact signal corresponding to a contact position of a contact object using impedances of a pair of touch patterns when the pair of touch patterns are contacted by the contact object.

The pair of touch patterns may be patterned such that a region formed of the conductive material is varied according to a coordinate axis position so that when the pair of touch patterns are contacted by the contact object, capacitances of the pair of touch patterns are varied according to the contact position of the contact object.

When the pair of touch patterns are contacted by the contact object, the touch sensor may determine a first position value corresponding to a first coordinate value using the capacitances of the touch patterns, set a position of the pair of touch patterns contacted by the contact object among the pairs of touch patterns to a second position value corresponding to a second coordinate value, and generate the contact signal corresponding to the first and second position values.

Even if a contact area is varied or the first position value is affected by external noise, the touch sensor may compensate for a variation in the first position value due to the contact area or the external noise and may determine the first position value corresponding to an actual position value of the contact object.

The touch sensor may compensate for the variation in the first position value using the average of values corresponding to the capacitances of the pair of touch patterns.

The touch sensor of the touch panel device may include: a reference signal generator for generating a clock signal; a delay signal generator for receiving the clock signal to generate at least two delay signals having delay times corresponding to the capacitances of the pair of touch patterns; and a contact position signal generator for setting a coordinate value corresponding to a difference and/or a summation of the delay signals to the first position value and setting the position of the pair of touch patterns from which the delay times are detected to the second position value to output the contact signal.

The delay signal generator of the touch panel device may include: a first signal generator connected to a first touch pattern of each of the pairs of touch patterns, the first signal generator for receiving the clock signal to generate a first delay signal delayed according to the capacitance of the first touch pattern; and a second signal generator connected to a second touch pattern of each of the pairs of touch patterns, the second signal generator for receiving the clock signal to generate a second delay signal delayed according to the capacitance of the second touch pattern.

The touch sensor of the touch panel device may include: a reference signal generator for generating a clock signal; a delay signal generator for receiving the clock signal to generate at least two delay signals having delay times corresponding to the capacitances of the pair of touch patterns and a comparison signal to be compared with the delay signals; and a contact position signal generator for comparing each of the two delay signals with the comparison signal, setting the average of contact position values corresponding to the delay times to the first position value, and setting the position of the pair of touch patterns from which the delay times are detected to the second position value to output the contact signal.

The delay signal generator of the touch sensor device may include: a first signal generator connected to a first touch pattern of each of the pair of touch patterns, the first signal generator for receiving the clock signal to generate a first delay signal delayed according to the capacitance of the first touch pattern; a second signal generator connected to a second touch pattern of each of the pairs of touch patterns, the second signal generator for receiving the clock signal to generate a second delay signal delayed according to the capacitance of the second touch pattern; and a comparison signal generator for receiving the clock signal to generate the comparison signal having a predetermined delay time.

Each of the pairs of touch patterns may be a cross-symmetric touch pattern.

Each of the pairs of touch patterns may be a right-triangular touch pattern.

The pair of touch patterns may be patterned such that a region formed of the conductive material is constant, irrespective of a coordinate axis position, so that when the pair of touch patterns are contacted by the contact object, resistances of the pair of touch patterns are varied according to the contact position of the contact object.

When the pair of touch patterns are contacted by the contact object, the touch sensor may determine a first position value corresponding to a first coordinate value using the resistances of the touch patterns, set a position of the pair of touch patterns contacted by the contact object among the pairs of touch patterns to a second position value corresponding to a second coordinate value, and generate the contact signal corresponding to the first and second position values.

Even if a contact area is varied or the first position value is affected by external noise, the touch sensor may compensate for a variation in the first position value due to the contact area or the external noise and may determine the first position value corresponding to an actual position value of the contact object.

The touch sensor of the touch panel device may include: a reference signal generator for generating a clock signal; a delay signal generator for receiving the clock signal to generate at least two delay signals having delay times corresponding to the resistances of the pair of touch patterns; and a contact position signal generator for setting a coordinate value corresponding to a difference and/or a summation of the delay signals to the first position value and setting the position of the pair of touch patterns from which the delay times are detected to the second position value to output the contact signal.

The delay signal generator of the touch panel device may include: a first signal generator connected to a first touch pattern of each of the pairs of touch patterns, the first signal generator for receiving the clock signal to generate a first delay signal delayed according to the resistance of the first touch pattern; and a second signal generator connected to a second touch pattern of each of the pairs of touch patterns, the second signal generator for receiving the clock signal to generate a second delay signal delayed according to the resistance of the second touch pattern.

The touch sensor may include: a reference signal generator for generating a clock signal; a delay signal generator for receiving the clock signal to generate at least two delay signals having delay times corresponding to the resistances of the pair of touch patterns and a comparison signal to be compared with the delay signals; and a contact position signal generator for comparing each of the two delay signals with the comparison signal, setting the average of contact position values corresponding to the delay times to the first position value, and setting the position of the pair of touch patterns from which the delay times are detected to the second position value to output the contact signal.

The delay signal generator of the touch panel device may include: a first signal generator connected to a first touch pattern of each of the pair of touch patterns, the first signal generator for receiving the clock signal to generate a first delay signal delayed according to the resistance of the first touch pattern; a second signal generator connected to a second touch pattern of each of the pairs of touch patterns, the second signal generator for receiving the clock signal to generate a second delay signal delayed according to the resistance of the second touch pattern; and a comparison signal generator for receiving the clock signal to generate the comparison signal having a predetermined delay time.

Each of the pairs of touch patterns may be symmetric touch patterns.

Each of the pairs of touch patterns may be rectangular touch patterns.

The conductive material may include indium tin oxide (ITO).

Another aspect of the present invention provides a method of detecting a contact position using a touch panel device having a surface on which at least one pair of touch patterns formed of a conductive material are formed. The method includes detecting varied impedances of the pair of touch patterns contacted by the contact object, determining a first-axis coordinate value using the impedances of the pair of touch patterns, setting a position of the pair of touch patterns contacted by the contact object among a plurality of pairs of touch patterns to a second-axis coordinate value, and generating a contact signal corresponding to the first- and second-axis coordinate values.

Determining the first-axis coordinate value may include generating a clock signal, delaying the clock signal by delay times corresponding to the impedances of the pair of touch patterns to generate a first clock delay signal and a second clock delay signal, and calculating the first-axis coordinate value corresponding to a difference and/or a summation of the first clock delay signal and the second clock delay signal.

Determining the first-axis coordinate value may include generating a clock signal, generating a comparison signal by delaying the clock signal by a predetermined delay time, delaying the clock signal by delay times corresponding to the impedances of the pair of touch patterns to generate a first clock delay signal and a second clock delay signal, determining a first position value corresponding to the delay time by comparing the first clock delay signal with the comparison signal, determining a second position value corresponding to the delay time by comparing the second clock delay signal with the comparison signal, and calculating the first-axis coordinate value corresponding to an average value of the first position value and the second position value. The impedance may be a capacitance.

Alternatively, the impedance may be a resistance.

### ADVANTAGEOUS EFFECTS

According to the present invention as explained thus far, a touch panel device includes a plurality of pairs of touch patterns formed of a conductive material. A first axis position of a touch panel is determined depending on whether the touch patterns are contacted by the contact object, and a second axis position of the touch panel is determined by detecting variations in capacitance of the touch patterns or delay times by which a reference signal applied to the touch patterns is delayed. Thus, a contact position of the contact object can be obtained using the first and second axis positions. Since the touch panel device according to the present invention uses a one-layer conductive material, for example, of ITO film, manufacturing the touch panel device with improved transparency can be easy and economical.

### BRIEF DESCRIPTION OF THE DRAWINGS

FIG. 1 is a plan view of a conventional capacitive touch panel.

FIG. 2 is a cross-sectional view of the conventional capacitive touch panel taken along line H-H′ of FIG. 1.

FIG. 3 is a view showing the construction of a touch panel device using a one-layer indium tin oxide (ITO) film according to an exemplary embodiment of the present invention.

FIG. 4 is a diagram illustrating a method of determining a Y-axis position of a contact object partially contacted by the touch panel device shown in FIG. 3.

FIG. 5 is a diagram illustrating a method of determining a Y-axis position of a contact object widely contacted by the touch panel device shown in FIG. 3.

FIG. 6 is a diagram illustrating a method of determining a Y-axis position of a contact object contacted by the touch panel device shown in FIG. 3 when noise occurs.

FIG. 7 is a view showing the construction of a touch panel device using a one-layer ITO film according to another exemplary embodiment of the present invention.

FIG. 8 is a block diagram of an example of a touch sensor using a pair of touch patterns for the touch panel device shown in FIG. 7.

FIG. 9 is a block diagram of another example of a touch sensor using a pair of touch patterns for the touch panel device shown in FIG. 7.

FIG. 10 is a view showing the construction of a touch panel device using a one-layer ITO film according to yet another exemplary embodiment of the present invention.

FIG. 11 is a block diagram of an example of the touch sensor using a pair of touch patterns for the touch panel device shown in FIG. 10.

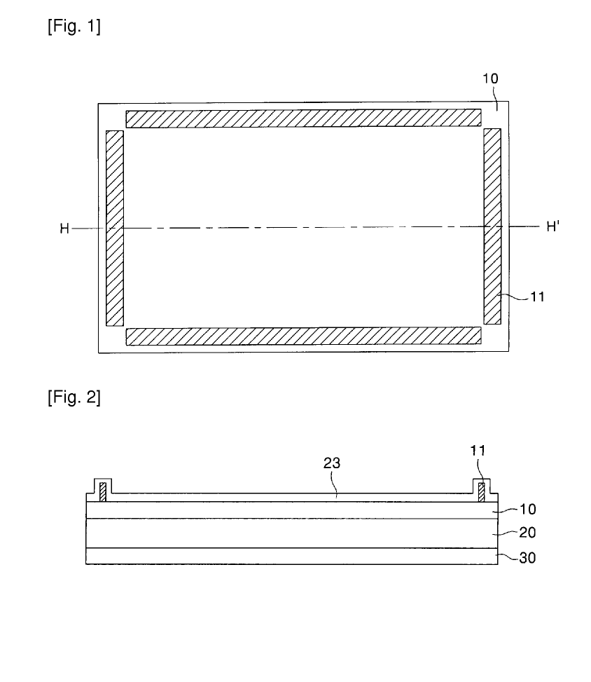

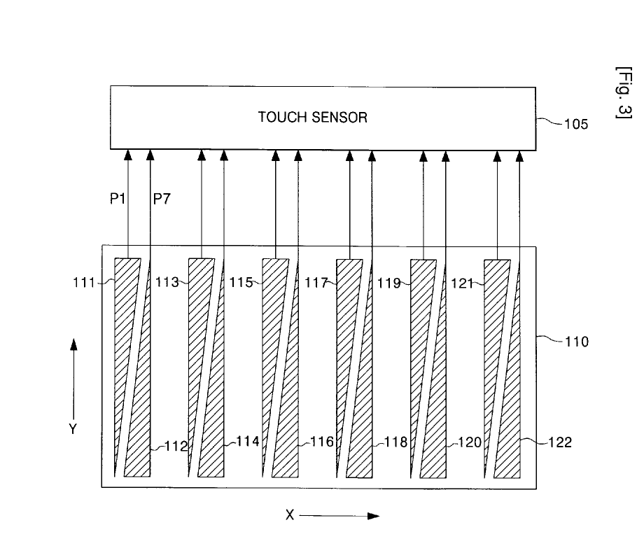

### MODE FOR THE INVENTION

Hereinafter, a touch panel device and a method of detecting a contact position thereof according to exemplary embodiments of the present invention will be described in detail.

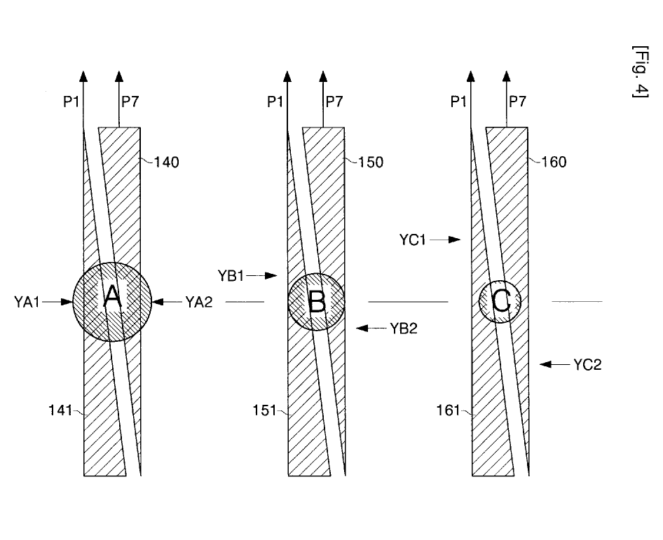

FIG. 3 is a view showing the construction of a touch panel device using a one-layer indium tin oxide (ITO) film according to an exemplary embodiment of the present invention.

Referring to FIG. 3, the touch panel device includes an ITO film 110 and a touch sensor 105.

Pairs of right-triangular touch patterns 111 to 122 are formed on the ITO film 110, and each of the pairs of touch patterns 111 to 122 are connected to the touch sensor 105.

When a contact object comes into contact with the touch patterns 111 to 122 the capacitances of the touch patterns 111 to 122 are varied. Thus, the position of the contact object can be detected by measuring variations in the capacitances of the touch patterns 111 to 122.

Although a plurality of the pairs of touch patterns 111 to 122 may be formed on the ITO film 110, it is assumed in the present embodiment that the touch panel device includes six pairs of touch patterns 111 to 122.

The six pairs of touch patterns 111 to 122 are formed in an X-axis direction on the ITO film 110 so that an X-axis position of the contact object depends on whether or not the touch patterns 110 to 122 are contacted by the contact object.

The capacitances of the pairs of touch patterns 111 to 122 are varied according to the areas of the touch patterns 111 to 122 that are contacted by the contact object in a Y-axis direction of the ITO film 110, so that a Y-axis position of the contact object depends on the capacitances.

Although a Y-axis resolution varies with a measurable capacitance, the present invention uses an 8-bit resolution (256 gray levels).

For example, when a contact object contacts the first pair of touch patterns 111 and 112, an X-axis position value is 1, and determination of a Y-axis position of the contact object includes detecting the capacitances of the pair of touch patterns 111 and 112, which are varied according to the areas of the touch patterns 111 and 112 contacted by the contact object, and setting a Y-axis coordinate corresponding to the capacitances.

In the present embodiment, even if the touch pattern 112 of the pair of touch patterns 111 and 112 and a touch pattern 113 of another pair of touch patterns 113 and 114 are simultaneously contacted by a contact object, since a pair of touch patterns 112 and 113 are contacted by the contact object, it is obvious that a contact position of the contact object can be determined.

The touch sensor 105 detects a contact object contacting the pairs of touch patterns 111 to 122 of the ITO film 110 and variations in capacitances of the pair of touch patterns 111 to 122 contacted by the contact object, so that a contact position of the contact object contacted by the ITO film 110 can be determined by the capacitances.

Here, it is obvious that X- and Y-axis position values may depend on arrangement of the pairs of touch patterns 111 to 122 on the ITO film 110.

When a plurality of the pairs of touch patterns 111 to 122 are contacted by a contact object, there may be many methods of detecting a contact position of the contact object. For example, X- and Y-axis position values of all the touch patterns 111 to 122 contacted by the contact object are obtained and the average thereof is calculated to determine the contact position of the contact object. However, for brevity, it is assumed in the present invention that only a pair of touch patterns are selected.

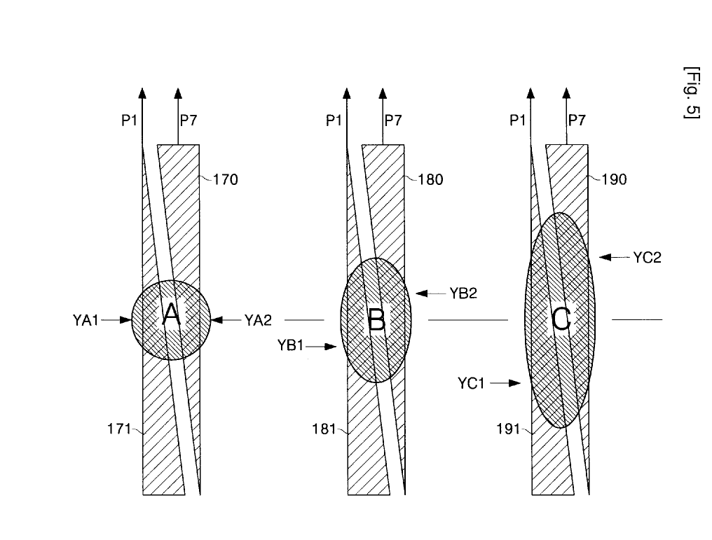

FIG. 4 is a diagram illustrating a method of determining a Y-axis position of a contact object partially contacted by the touch panel device shown in FIG. 3.

FIG. 4 includes a plurality of pairs of touch patterns and contact areas A, B, and C.

Hereinafter, a method of determining a Y-axis position of a contact object partially contacted by the touch panel device will be described with reference to FIGS. 3 and 4.

A pair of touch patterns 140 and 141 are connected to the touch sensor 105 through connection lines P1 and P7. As the contact object contacts the touch pattern towards the touch sensor 105, the capacitance of the touch pattern 140 detected by the touch sensor 105 increases, while the capacitance of the touch pattern 141 detected by the touch sensor 105 decreases. This is because as a contact area between a touch pattern and a contact object (i.e., an overlapping area of the touch pattern and the contact object) increases, a capacitance induced by the contact object also increases.

First, the pair of touch patterns 140 and 141 may be ideally contacted by the contact object in a contact area A. In this case, a capacitance YA2 of the touch pattern 140 is equal to a capacitance YA1 of the touch pattern 141. Thus, a Y-axis coordinate value corresponding to the capacitance YA2 may be equal to a Y-axis coordinate value corresponding to the capacitance YA1.

Second, when a pair of touch patterns 150 and 151 are contacted by a contact object in a contact area B that is smaller than the contact area A, since a capacitance of a touch pattern is proportional to a contact area, capacitances YB2 and YB1 of the pair of touch patterns 150 and 151 are reduced as compared with when the pair of touch patterns 140 and 141 are contacted by the contact object in the contact area A. Thus, a Y-axis coordinate value of the touch pattern 150 decreases due to the reduced capacitance YB2 corresponding thereto, while a Y-axis coordinate value of the touch pattern 151 increases due to the reduced capacitance YB1 corresponding thereto.

Third, when a pair of touch patterns 160 and 161 are contacted by a contact object in a contact area C that is smaller than the contact area B, since a capacitance of a touch pattern is proportional to a contact area, capacitances YC2 and YC1 of the pair of touch patterns 160 and 161 are reduced as compared with when the pair of touch patterns 150 and 151 are contacted by the contact object in the contact area B.

Thus, a Y-axis coordinate value of the touch pattern 160 decreases due to the decreasing capacitance YC2 corresponding thereto, while a Y-axis coordinate value of the touch pattern 161 increases due to the reduced capacitance.

When a contact object partially contacts touch patterns as described above, as a contact area decreases, the capacitances of the touch patterns also decrease. Thus, coordinate values corresponding to capacitances of the respective touch patterns are set and the average of the coordinate values is calculated to determine a contact position of the contact object.

When setting coordinate values corresponding to the capacitances of the touch patterns, it is obvious that determination of the contact position of the contact object may include repetitively detecting the capacitances of the touch patterns, calculating the averages of a plurality of coordinate values corresponding to the capacitances of the touch patterns, and calculating the average of the average coordinate values of the respective touch patterns.

As described above, as an overlapping area of a contact object and a pair of touch patterns decreases, a difference between Y-axis coordinate values corresponding to capacitances of the touch patterns increases. Thus, the average of coordinate values corresponding to the capacitances of the pair of touch patterns is obtained in the above-described manner to correspond to positions of the touch patterns, thereby compensating a contact position of the contact object.

Although it is exemplarily described that a Y-axis position of a contact object is determined by obtaining the average of Y-axis coordinate values, it is obvious that the Y-axis position of the contact object may be determined using any other calculating methods using Y-axis coordinate values corresponding to capacitances of touch patterns.

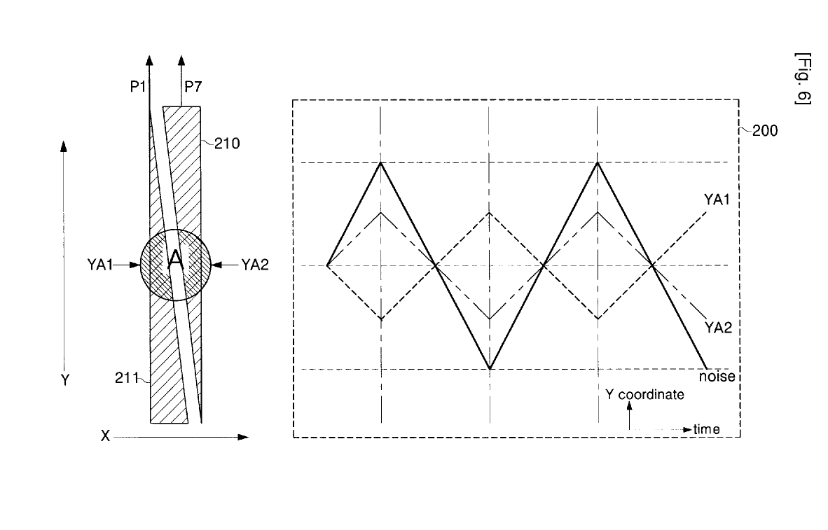

FIG. 5 is a diagram illustrating a method of determining a Y-axis position of a contact object widely contacted by the touch panel device shown in FIG. 3.

Hereinafter, a method of determining a Y-axis position of a contact object widely contacted by the touch panel device will be described with reference to FIGS. 3 and 5.

When a contact object widely contacts the touch patterns as shown in FIG. 5, a contact position of the contact object is determined in the same manner as described with reference to FIG. 4.

First, a pair of touch patterns 170 and 171 may be ideally contacted by a contact object in a contact area A. In this case, a capacitance YA2 of the touch pattern 170 is equal to a capacitance YA1 of the touch pattern 171. Thus, a Y-axis coordinate value corresponding to the capacitance YA2 may be equal to a Y-axis coordinate value corresponding to the capacitance YA1.

Second, when a pair of touch patterns 180 and 181 are contacted by a contact object in a contact area B that is greater than the contact area A, since a capacitance of a touch pattern is proportional to a contact area, capacitances YB1 and YB2 of the pair of touch patterns 180 and 181 are increased as compared with when the pair of touch patterns 170 and 171 are contacted by the contact object in the contact area A. Thus, a Y-axis coordinate value of the touch pattern 180 increases due to the increased capacitance YB2 corresponding thereto, while a Y-axis coordinate value of the touch pattern 181 decreases due to the increased capacitance YB1 corresponding thereto.

Third, when a pair of touch patterns 190 and 191 are contacted by a contact object in a contact area C that is greater than the contact area B, since a capacitance of a touch pattern is proportional to a contact area, capacitances YC2 and YC1 of the pair of touch patterns 190 and 191 are increased as compared with when the pair of touch patterns 180 and 181 are contacted by the contact object in the contact area B. Thus, a Y-axis coordinate value of the touch pattern 190 increases due to the increased capacitance YC2 corresponding thereto, while a Y-axis coordinate value of the touch pattern 191 decreases due to the increased capacitance YC1.

Unlike in the case of FIG. 4, when a contact object widely contacts a pair of touch patterns, as a contact area between the contact object and the touch patterns increases, capacitances of the touch patterns increase. However, like in the case of FIG. 4, the average of coordinate values corresponding to the capacitances of the pair of touch patterns can be obtained, thereby compensating for a contact position of the contact object.

FIG. 6 is a diagram illustrating a method of determining a Y-axis position of a contact object contacted by the touch panel device shown in FIG. 3 when noise occurs.

FIG. 6 illustrates a graph 200 showing a variation by noise of Y-axis coordinate values of the touch patterns 210 and 211.

A method of determining a Y-axis position of a contact object when noise occurs will now be described.

A pair of touch patterns 210 and 211 are contacted by a contact object in a contact area A. In this case, capacitances of the touch patterns 210 and 211 are varied due to external noise, and thus Y-axis coordinate values corresponding to the capacitances of the touch pattern 210 and 211 are varied as shown in the graph 200.

Y-axis coordinate values YA2 and YA1 of the touch patterns 210 and 211 contacted by the contact object may be increased or decreased under the influence of external noise. The noise produces the same phenomenon as capacitance changes When the noise of the touch pattern 210 increases, the Y-axis coordinate value YA2 corresponding thereto also increases. When the noise of the touch pattern 211 increases, the Y-axis coordinate value YA1 corresponding thereto decreases. Thus, the Y-axis position of the contact object can be obtained without the influence of noise by calculating the average of the Y-axis coordinate values corresponding to the capacitances of the touch patterns 210 and 211.

For instance, it is assumed that the pair of touch patterns 210 and 211 have a length of 100 and a total Y-axis coordinate value of 100. In this case, when the capacitance of the touch pattern 210 is 90, a Y-axis coordinate value thereof is 90. Also, when the capacitance of the touch pattern 211 is 10, a Y-axis coordinate value thereof is 90. Thus, the average of the Y-axis coordinate values of the touch patterns 210 and 211 is calculated to obtain an absolute Y-axis coordinate value of 90. Similarly, when the measured capacitances of the touch pattern 210 and 211 are increased under the influence of noise, the touch pattern 210 having a capacitance of 95 has a Y-axis coordinate value of 95, while the touch pattern 211 having a capacitance of 15 has a Y-axis coordinate value of 85. Thus, the average of the Y-axis coordinate values of the touch pattern 210 and 211 is calculated to obtain an absolute Y-axis coordinate value of 90, which is the same as the absolute Y-axis coordinate value obtained without the influence of noise.

This is because the right-triangular touch patterns 210 and 211 with opposite oblique sides are cross-symmetric.

As described above, according to a method of detecting a contact position of a contact object using a touch panel device according to the present invention, by use of a one-layer ITO film, capacitances of a pair of touch patterns are measured, the Y-axis coordinate values corresponding to the capacitances of the touch patterns are obtained and the average of Y-axis coordinate values of the touch patterns is calculated, thereby compensating for a Y-axis contact position.

However, it is obvious that maximum and minimum capacitances of respective touch patterns are set and varied capacitances of the touch patterns are obtained by bringing a contact object into contact with the touch patterns to directly compare with the maximum and minimum capacitances, and the touch panel device may thereby determine a contact position of the contact object. Here, an interpolating technique that calculates from the varied capacitances and range of the maximum and minimum capacitances can produce a finer resolution than an actual resolution from the measured capacitances.

Further, the method of detecting a contact position may use an interpolation method of calculating the contact position, and setting measured maximum and minimum capacitance as maximum and minimum capacitance, to correspond to the set maximum and minimum capacitance of average Y-axis coordinate values.

Using the interpolation method as described above, the Y-axis resolution can be more accurate.

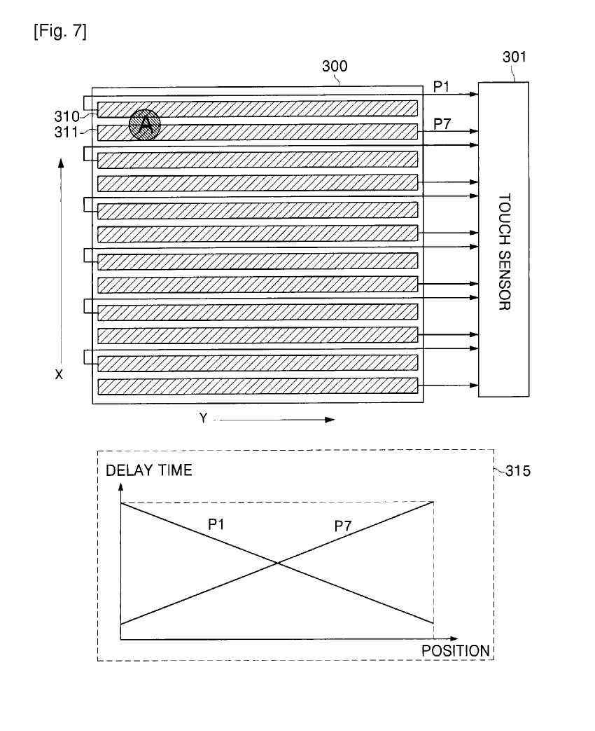

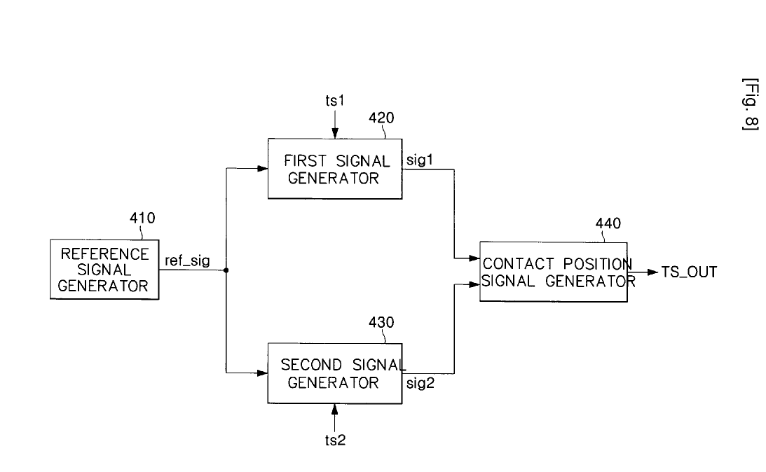

FIG. 7 is a view showing the construction of a touch panel device using a one-layer ITO film according to another exemplary embodiment of the present invention.

Referring to FIG. 7, the touch panel device includes an ITO film 300, a touch sensor 301, and pairs of bar-shaped touch patterns 310 and 311. In addition, FIG. 7 illustrates a graph 315 showing a delay time relative to a contact position.

One ends of the bar-shaped touch patterns 310 and other ends of the bar-shaped touch patterns 311 are alternately connected to the touch sensor 301, respectively. In the touch panel device shown in FIG. 7, a contact position of a contact object can be determined by detecting a resistance that varies with the contact position of the contact object.

For example, when a contact object (e.g., a finger) is brought into contact with a contact area A, a resistance of the touch pattern 310 becomes lower than that of the touch pattern 311. Conversely, the resistance of the touch pattern 311 becomes higher than that of the touch pattern 310. Therefore, a contact position of the touch patterns 310 and 311 can be determined by calculating the average of values corresponding to the resistance of the touch patterns 310 and 311.

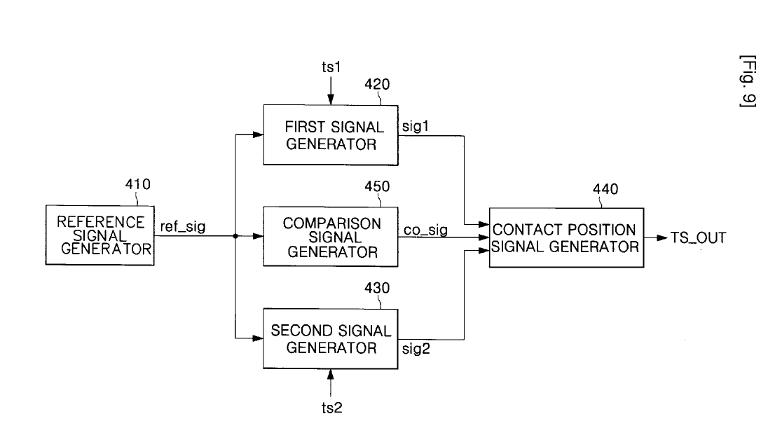

As like as the previous exemplary, averaging the positions from the touch patterns 310 and 311 can compensate various touch cases and external noises. FIG. 8 is a block diagram of an example of a touch sensor using a pair of touch patterns for the touch panel device shown in FIG. 7.

Referring to FIG. 8, the touch sensor includes a reference signal generator 410, a first signal generator 420, a second signal generator 430, and a contact position signal generator 440.

The components of the touch sensor shown in FIG. 8 will now be described with reference to FIG. 7.

The reference signal generator 410 generates a clock signal as a reference signal ref_sig and applies the clock signal to each of the first and second signal generators 420 and 430.

The first signal generator 420 is connected to the first touch pattern 310 of the pair of touch patterns 310 and 311 and detects a resistance ts1 of the first touch pattern 310. When the first touch pattern 310 is contacted by a contact object, the first signal generator 420 delays the reference signal ref_sig by a first time in response to the resistance ts1 and generates a first signal sig1.

The second signal generator 430 is connected to the second touch pattern 311 of the pair of touch pattern 310 and 311 and detects a resistance ts2 of the second touch pattern 311. When the second touch pattern 311 is contacted by a contact object, the second signal generator 430 delays the reference signal ref_sig by a second time in response to the resistance ts2 and generates a second signal sig2.

Although it is described that the first and second signal generators 420 and 430 delay the reference signal ref_sig according to varied resistances of the first and second touch patterns 310 and 311, it is obvious that the first and second signal generators 420 and 430 delay the reference signal ref_sig according to the capacitances of the first and second touch pattern 310 and 311.

The contact position signal generator 440 receives the first and second signals sig1 and sig2, compares the first signal sig1 with the second signal sig2 to obtain a difference and/or a summation in delay time between the first and second signals sig1 and sig2, sets a Y-axis coordinate value corresponding to the delay time difference and/or summation, detects positions of the touch patterns 310 and 311 contacted by the contact object to obtain an X-axis coordinate value, and outputs a contact position signal TS_OUT corresponding to the obtained X- and Y-axis coordinate values. For example here, the summation is delay time sum that may be used to calculate an average value for compensating for the various touch cases contact conditions and external noise, while the delay time difference and/or summation are sum that may be used to calculate interpolation coordinate values by an interpolation method.

Using the touch sensor of FIG. 8, not only the resistances of the touch patterns 310 and 311 but also a capacitance caused by the contact object (e.g., the finger) may result in a delay time. Also, the interconnection lines P1 and P7 for connecting the touch patterns 310 and 311 to the touch sensor 301 may have the same length.

The graph 315 of FIG. 7 shows a delay time relative to a contact position of a contact object. In the graph 315, an X axis denotes a position of the contact object contacted by the touch patterns 310 and 311, and a Y axis denotes a delay time corresponding thereto. As a delay time of the touch pattern 310 increases, a delay time of the touch pattern 311 decreases.

As in the previous exemplary embodiment, averaging the resistance or capacitance of the touch patterns 310 and 311 can compensate for various contact cases and external noises

Although the present invention exemplarily describes a touch sensor including a pair of touch patterns, it is obvious that the touch sensor may include a plurality of touch patterns, a plurality of first signal generators 420, a plurality of second signal generators 430, and a plurality of contact signal generators 440.

Also, X-axis positions of touch patterns contacted by a contact object can be determined by assigning numbers to a plurality of touch patterns in good order in an X-axis direction.

Since the above-described contact position signal generator 440 obtains a final Y-axis coordinate value using the generated delay time differences and/or summations of a pair of touch patterns, when the touch patterns are partially or widely contacted by a contact object or the capacitances of the touch patterns are varied due to noise, the variations can be compensated for and the Y-axis coordinate value can be obtained.

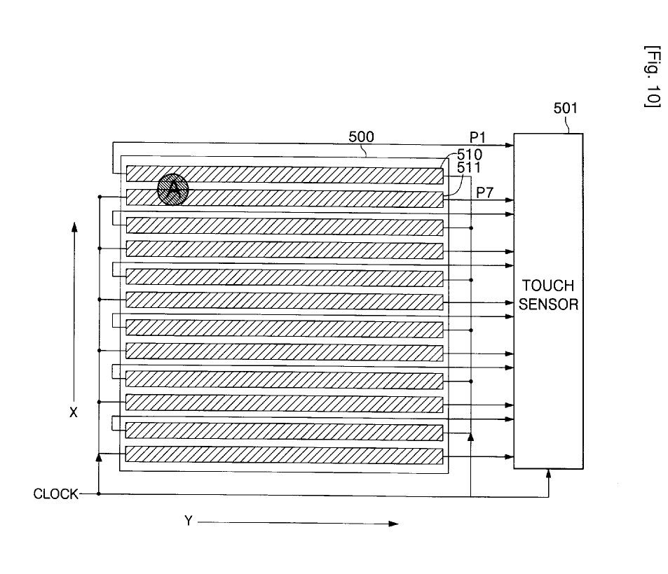

FIG. 9 is a block diagram of another example of a touch sensor using a pair of touch patterns for the touch panel device shown in FIG. 7.

Referring to FIG. 9, the touch sensor includes a reference signal generator 410, a first signal generator 420, a second signal generator 430, a contact position signal generator 440, and a comparison signal generator 450.

The components of the touch sensor of FIG. 9 will now be described with reference to FIG. 7. Here, the constructions and functions of the reference signal generator 410 and the first and second signal generators 420 and 430 are the same as those of FIG. 8, and thus they will not be described.

The comparison signal generator 450 delays a reference signal ref_sig by a predetermined time irrespective of resistances of the touch patterns 310 and 311 and generates a comparison signal co_sig.

The contact position signal generator 440 receives a first signal sig1, a second signal sig2, and the comparison signal co_sig, compares the first signal sig1 with the comparison signal co_sig to obtain a first delay time, compares the second signal sig2 with the comparison signal co_sig to obtain a second delay time, sets a first Y-axis coordinate value corresponding to the first delay time, sets a second Y-axis coordinate value corresponding to the second delay time, obtains the average of the first and second Y-axis coordinate values as a final Y-axis coordinate value, detects positions of the touch patterns 310 and 311 contacted by a contact object to obtain an X-axis coordinate value, and outputs a contact position signal TS_OUT corresponding to the obtained X- and Y-axis coordinate values.

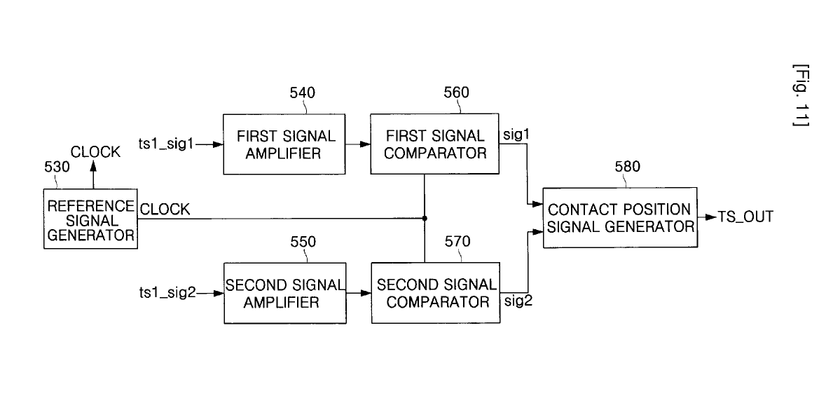

FIG. 10 is a view showing the construction of a touch panel device using a one-layer ITO film according to yet another exemplary embodiment of the present invention.

Referring to FIG. 10, the touch panel device includes an ITO film 500, a touch sensor 501, and pairs of bar-shaped touch patterns 510 and 511.

The touch panel device using the one-layer ITO film 500 will now be described with reference to FIG. 10.

One ends of the bar-shaped touch patterns 510 and other ends of the bar-shaped touch patterns 511 are alternately connected to the touch sensor 501, respectively. Also, a reference signal CLOCK is applied to the opposite end of the far ends of each of the touch patterns 510 connected to the touch sensor 501 and the opposite ends of the near ends of each of the touch patterns 511 connected to the touch sensor 501. In the touch panel device shown in FIG. 10, a contact position of a contact object can be determined by detecting a delay time of the reference signal CLOCK that varies with the contact position of the contact object.

For example, when a contact object (e.g., a finger) is brought into contact with a contact area A, the reference signal CLOCK applied to the touch pattern 510 is delayed according to a capacitance and resistance between a portion of the touch pattern 510 to which the reference signal CLOCK is applied and a portion of the touch pattern 510 is contacted by the contact object to generate a delay signal P1. Similarly, the reference signal CLOCK applied to the touch pattern 511 is delayed according to a capacitance and resistance between a portion of the touch pattern 511 to which the reference signal CLOCK is applied and a portion of the touch pattern 511 is contacted by the contact object to generate a delay signal P7. Thus, the touch sensor 501 can determine the contact position of the touch patterns 510 and 511 by comparing the two delayed signals P1 and P7 with the not-delayed reference signal CLOCK and calculating the average of the values corresponding to the delayed times.

FIG. 11 is a block diagram of a touch sensor using a pair of touch patterns included in the touch panel device shown in FIG. 10.

Referring to FIG. 11, the touch sensor includes a reference signal generator 530, a first signal amplifier 540, a second signal generator 550, a first signal comparator 560, a second signal comparator 570, and a contact position signal generator 580.

The components of the touch sensor shown in FIG. 11 will now be described with reference to FIG. 10.

The reference signal generator 530 generates a clock signal as a reference signal CLOCK and applies the clock signal to each of the touch patterns 510 and 511, the first signal comparator 560, and the second signal comparator 570.

The touch pattern 510 receives the reference signal CLOCK and outputs a first delay clock signal ts1_sig1 (corresponding to P1 of FIG. 10), and the first signal amplifier 540 receives the first delay clock signal ts1_sig1, amplifies the first delay clock signal ts1_sig1, and outputs the amplified signal.

The first signal comparator 560 receives the amplified first delay clock signal and the reference signal CLOCK, compares the two signals, and generates a first signal sig1 corresponding to a delay time by which the first delay clock signal ts1_sig1 is delayed.

The touch pattern 511 receives the reference signal CLOCK and outputs a second delay clock signal ts1_sig2 (corresponding to P7 of FIG. 10), and the second signal amplifier 550 receives the second delay clock signal ts1_sig2, amplifies the second delay clock signal ts1_sig2, and outputs the amplified signal.

The second signal comparator 570 receives the amplified second delay clock signal and the reference signal CLOCK, compares the two signals, and generates a second signal sig2 corresponding to a delay time by which the second delay clock signal ts1_sig2 is delayed.

The contact position signal generator 580 receives the first and second signals sig1 and sig2, sets Y-axis coordinate values corresponding to the first and second signals sig1 and sig2, calculates the average of the two Y-axis coordinate values to determine a final Y-axis coordinate value, detects positions of the touch patterns 510 and 511 contacted by a contact object to obtain an X-axis coordinate value, and outputs a contact position signal TS_OUT corresponding to the obtained X- and Y-axis coordinate values.

Here, the first and second signal comparators 560 and 570 may be omitted and the contact position signal generator 580 can perform not only its own operation but also the above-described operations of the first and second signal comparators 560 and 570.

Although the present invention exemplarily describes a touch sensor including a pair of touch patterns, it is obvious that the touch sensor may include a plurality of touch patterns.

Also, the present invention exemplarily describes a touch sensor including a pair of touch patterns (i.e., two touch patterns). However, it is obvious that the touch sensor may include a single touch pattern, a single signal amplifier, a single signal comparator, and a contact position signal generator and may compare a delay signal with a reference signal to thereby obtain a Y-axis coordinate value corresponding to a delay time.

Since the above-described contact position signal generator 580 obtains the final Y-axis coordinate value using the average of the Y-axis coordinate values of the touch patterns, when the touch patterns are partially or widely contacted by a contact object or the capacitances of the touch patterns are varied due to noise, the variations can be compensated for and the Y-axis coordinate value can be and obtained.

As described above, a touch panel using a one-layer ITO film can determine a contact position of a contact object using a pair of touch patterns, and the touch patterns can be manufactured in various shapes.

While the invention has been shown and described with reference to certain exemplary embodiments thereof, it will be understood by those skilled in the art that various changes in form and details may be made therein without departing from the spirit and scope of the invention as defined by the appended claims.

1. A touch panel device comprising:
a touch panel having a surface on which at least one pair of touch patterns formed of a conductive material are formed; and
a touch sensor for generating a contact signal corresponding to a contact position of a contact object using impedances of a pair of touch patterns when the pair of touch patterns are contacted by the contact object.

2. The device according to claim 1, wherein the pair of touch patterns are patterned such that a region formed of a conductive material is varied according to a coordinate axis position so that when the pair of touch patterns are contacted by the contact object, capacitances of the pair of touch patterns are varied according to the contact position of the contact object.

3. The device according to claim 2, wherein when the pair of touch patterns are contacted by the contact object, the touch sensor determines a first position value corresponding to a first coordinate value using the capacitances of the touch patterns, sets a position of the pair of touch patterns contacted by the contact object among the pairs of touch patterns to a second position value corresponding to a second coordinate value, and generates the contact signal corresponding to the first and second position values.

4. The device according to claim 3, wherein even if a contact area is varied or the first position value is affected by external noise, the touch sensor compensates for a variation in the first position value due to the contact area or the external noise and determines the first position value corresponding to an actual position value of the contact object.

5. The device according to claim 4, wherein the touch sensor compensates for the variation in the first position value using an average of values corresponding to the capacitances of the pair of touch patterns.

6. The device according to claim 3, wherein the touch sensor comprises:
a reference signal generator for generating a clock signal;
a delay signal generator for receiving the clock signal to generate at least two delay signals having delay times corresponding to the capacitances of the pair of touch patterns; and
a contact position signal generator for setting a coordinate value corresponding to a difference and/or a summation of the delay signals to the first position value and setting the position of the pair of touch patterns from which the delay times are detected to the second position value to output the contact signal.

7. The device according to claim 6, wherein the delay signal generator comprises:
a first signal generator connected to a first touch pattern of each of the pairs of touch patterns, the first signal generator for receiving the clock signal to generate a first delay signal delayed according to the capacitance of the first touch pattern; and
a second signal generator connected to a second touch pattern of each of the pairs of touch patterns, the second signal generator for receiving the clock signal to generate a second delay signal delayed according to the capacitance of the second touch pattern.

8. The device according to claim 3, wherein the touch sensor comprises:
a reference signal generator for generating a clock signal;
a delay signal generator for receiving the clock signal to generate at least two delay signals having delay times corresponding to the capacitances of the pair of touch patterns and a comparison signal to be compared with the delay signals; and
a contact position signal generator for comparing each of the two delay signals with the comparison signal, setting the average of contact position values corresponding to the delay times to the first position value, and setting the position of the pair of touch patterns from which the delay times are detected to the second position value to output the contact signal.

9. The device according to claim 8, wherein the delay signal generator comprises:
a first signal generator connected to a first touch pattern of each of the pair of touch patterns, the first signal generator for receiving the clock signal to generate a first delay signal delayed according to the capacitance of the first touch pattern;
a second signal generator connected to a second touch pattern of each of the pairs of touch patterns, the second signal generator for receiving the clock signal to generate a second delay signal delayed according to the capacitance of the second touch pattern; and
a comparison signal generator for receiving the clock signal to generate the comparison signal having a predetermined delay time.

10. The device according to claim 2, wherein each of the pairs of touch patterns is a cross-symmetric touch pattern.

11. The device according to claim 2, wherein each of the pairs of touch patterns is a right-triangular touch pattern.

12. The device according to claim 1, wherein the pair of touch patterns are patterned such that a region formed of the conductive material is constant, irrespective of a coordinate axis position, so that when the pair of touch patterns are contacted by the contact object, resistances of the pair of touch patterns are varied according to the contact position of the contact object.

13. The device according to claim 12, wherein when the pair of touch patterns are contacted by the contact object, the touch sensor determines a first position value corresponding to a first coordinate value using the resistances of the touch patterns, sets a position of the pair of touch patterns contacted by the contact object among the pairs of touch patterns to a second position value corresponding to a second coordinate value, and generates the contact signal corresponding to the first and second position values.

14. The device according to claim 13, wherein even if a contact area is varied or the first position value is affected by external noise, the touch sensor compensates for a variation in the first position value due to the contact area or the external noise and determines the first position value corresponding to an actual position value of the contact object.

15. The device according to claim 14, wherein the touch sensor compensates for the variation in the first position value using an average of values corresponding to the resistances of the pair of touch patterns.

16. The device according to claim 13, wherein the touch sensor comprises:
a reference signal generator for generating a clock signal;
a delay signal generator for receiving the clock signal to generate at least two delay signals having delay times corresponding to the resistances of the pair of touch patterns; and
a contact position signal generator for setting a coordinate value corresponding to a difference and/or a summation of sum of the delay signals to the first position value and setting the position of the pair of touch patterns from which the delay times are detected to the second position value to output the contact signal.

17. The device according to claim 16, wherein the delay signal generator comprises:
a first signal generator connected to a first touch pattern of each of the pairs of touch patterns, the first signal generator for receiving the clock signal to generate a first delay signal delayed according to the resistance of the first touch pattern; and
a second signal generator connected to a second touch pattern of each of the pairs of touch patterns, the second signal generator for receiving the clock signal to generate a second delay signal delayed according to the resistance of the second touch pattern.

18. The device according to claim 13, wherein the touch sensor comprises:
a reference signal generator for generating a clock signal;
a delay signal generator for receiving the clock signal to generate at least two delay signals having delay times corresponding to the resistances of the pair of touch patterns and a comparison signal to be compared with the delay signals; and
a contact position signal generator for comparing each of the two delay signals with the comparison signal, setting the average of contact position values corresponding to the delay times to the first position value, and setting the position of the pair of touch patterns from which the delay times are detected to the second position value to output the contact signal.

19. The device according to claim 18, wherein the delay signal generator comprises:
a first signal generator connected to a first touch pattern of each of the pair of touch patterns, the first signal generator for receiving the clock signal to generate a first delay signal delayed according to the resistance of the first touch pattern;
a second signal generator connected to a second touch pattern of each of the pairs of touch patterns, the second signal generator for receiving the clock signal to generate a second delay signal delayed according to the resistance of the second touch pattern; and
a comparison signal generator for receiving the clock signal to generate the comparison signal having a predetermined delay time.

20. The device according to claim 12, wherein each of the pairs of touch patterns is a symmetric touch pattern.

21. The device according to claim 12, wherein each of the pairs of touch patterns is a rectangular touch pattern.

22. The device according to claim 1, wherein the conductive material comprises substantially indium tin oxide (ITO).

23. A method of detecting a contact position using a touch panel device having a surface on which at least one pair of touch patterns formed of a conductive material are formed, comprising:
detecting varied impedances of a pair of touch patterns contacted by a contact object;
determining a first-axis coordinate value using the impedances of the pair of touch patterns;
setting a position of the pair of touch patterns contacted by the contact object among the pairs of touch patterns to a second-axis coordinate value; and
generating a contact signal corresponding to the first- and second-axis coordinate values.

24. The method according to claim 23, wherein determining the first-axis coordinate value includes:
generating a clock signal;
delaying the clock signal by delay times corresponding to the impedances of the pair of touch patterns to generate a first clock delay signal and a second clock delay signal; and
calculating the first-axis coordinate value corresponding to a difference and/or summation of the first clock delay signal and the second clock delay signal.

25. The method according to claim 23, wherein determining the first-axis coordinate value includes:
generating a clock signal;
generating a comparison signal by delaying the clock signal by a predetermined delay time;
delaying the clock signal by delay times corresponding to the impedances of the pair of touch patterns to generate a first clock delay signal and a second clock delay signal;
determining a first position value corresponding to the delay time by comparing the first clock delay signal with the comparison signal;
determining a second position value corresponding to the delay time by comparing the second clock delay signal with the comparison signal; and
calculating the first-axis coordinate value corresponding to an average value of the first position value and the second position value.

26. The method according to claim 23, wherein the impedance is a capacitance.

27. The method according to claim 23, wherein the impedance is a resistance.
